(19) United States
(12) Patent Application Publication
(10) Pub. No.: US 2008/0162069 A1
(43) Pub. Date: Jul. 3, 2008

(54) Method And Device For the Dynamic Treatment of Objects

(76) Inventors: Nicola Bruski, Paderborn (DE); Ralf Grosse Boerger, Paderborn (DE); Holger Krisp, Barsighausen (DE); Robert Leinfellner, Paderborn (DE); Eduard Miller, Salzkotten (DE); Jobst Richert, Lippstadt (DE); Thomas Woelfer, Paderborn (DE)

Correspondence Address: CHADBOURNE & PARKE LLP, 30 ROCKEFELLER PLAZA, NEW YORK, NY, 10112, US

(21) Appl. No.: 11/963,370

(22) Filed: Dec. 21, 2007

(30) Foreign Application Priority Data
Dec. 21, 2006 (DE) 10 2006 061 796.7

(51) Int. Cl. G06F 19/00

(52) U.S. Cl. 702/108

(57) ABSTRACT

A method and a device for the dynamic treatment of objects in a test design are described and presented. According to this method, the test design comprises at least two bidirectionally exchanging systems and at least one additional system to be tested. Objects of a first type belong to an environment model, which is executed on a first system, and these objects can be processed by a test model.

The inventive method prevents the drawbacks known from the prior art, in that objects of a second type that are similar or identical to the objects of the first type are generated; and the objects of a first and a second type are made available to at least one of the systems by means of a management device.

The invention relates to a method for the dynamic treatment of objects in a test design. According to this method, the test design comprises at least two bidirectionally exchanging systems and at least one additional system to be tested. Objects of a first type belong to an environment model, which is executed on a first system, and these objects are processed by a test model. Furthermore, the invention relates to a management device for the treatment of objects.

Methods and devices of test designs for testing a system exist in a variety of forms in the field and are used primarily in applied research and industrial development in the wide field of development and in the application of electronic systems. This application is also used widely wherever process control problems have to be solved in the broadest sense. The term “control system” is used below as an all embracing term for a technical device, which is used essentially for the tasks of measuring, controlling, regulating, and calibrating. In the broadest sense the control system is generally an electronic, program-controllable system, which is called, for example, a control unit in the field of automotive applications. The term “control system” is not restricted to what is defined in the narrow sense as a control in systems theory; adjustments are typically implemented on control systems.

For the sake of greater comprehension, the basic idea of the invention is elucidated by means of a control unit that is employed in the automotive context. This field of application does not constitute a restriction with respect to the inventive idea.

The essential characteristics of such a test design are the presence of at least two similar individual systems, which may act and react repeatedly—but not necessarily—autonomously; a (usually) bidirectional data link and a specific built-in dependency between the systems. Such a built-in dependency stems, for example, from operating a complicated environment model on a distributed test device. In this case it becomes clear that a comprehensive model, which is executed on a plurality of test devices, exhibits a contextual (built-in) correlation. Other forms of dependency, for example an experiment system (referred to hereinafter as the experiment PC), which monitors the implementation, and a suitable test system for the implementation (hereinafter referred to as the test device) are also conceivable.

Programs, which represent a specific algorithm, are referred to below as the environment model. These programs represent functionalities in a specific context, and interact—by means of suitable simulation software—with other systems, for example the control systems in such a manner that the functions of the control system are detectable. A known example is an environment model for testing an automobile engine control unit. In this case the environment model represents an engine, which is controlled by the control unit, with the high accuracy that is required for the function of the control unit. The environment model serves the sensors of the control unit and reacts (virtually) to the actuators of the control unit. It is not absolutely mandatory for an environment model to interact directly with a control system. It is also conceivable that—in the expanded version of the said example—an engine control unit is connected to an engine to be tested. This engine in turn is connected to an expanded environment model of a vehicle, which represents, for example, a transmission or a chassis with associated sensors, actuators and functionality.

The development of a control system, which can be put ultimately into mass production, is usually carried out in the following steps. In the function development the first step is to design a controller by means of mathematical modelling tools in such a way that the subsequent target hardware and environment can be ignored. In this case, the controller, which is developed in this way, is tested only in a simulation with the process mapping that also exists only as a mathematical model.

In a next step—the so-called rapid control prototyping (RCP)—the abstract controller design is translated into an executable program by means of code generators. Said program is operated on a control system, which can run in real time and is usually very powerful—and cannot be compared with the serial control system that is employed in the end. Then this RCP control system interacts by means of the respective I/O interfaces with the real process to be influenced. If these results are satisfactory, executable code for the serial control system is generated in turn from the mathematical model of the controller by means of suitably equipped code generators, so that the control system, which is actually used in the serial application, can be provided with the functionality, with which it must also be equipped in serial application.

However, before the serial control system is tested in connection with the real process, it is subjected to comprehensive tests—so-called hardware in the loop tests (HIL tests). In the HIL tests the (serial) control system is connected to a test device. The test device uses an environment model to simulate the functional environment of the control system to be tested. Thus, the control system interacts with a virtual environment by connecting via a data channel the environment model to the test device by outputting environment model data over the test device to the control system and by receiving control system data from the control system.

In the field of automotive applications the control system can be, for example, an engine control unit. Then the environment model of this engine control unit is an engine model, which is operated on the test device in real time. However, it could just as well be a flight and engine dynamic model of an entire aircraft, which is moved in a virtual environment. In principle, the environment model does not have to cover all interfaces of the control system to be tested. Rather any part of the environment can be implemented by means of real components. In the preceding example this could mean that the control system to be tested is actually connected to a real internal combustion engine. In this case the environment of the engine (for example, the transmission, the drive train, the chassis and the road) is reproduced with the aid of an environment model that runs on the test device. Therefore, the environment model does not have to be a comprehensive environment model, but rather it can be connected directly and/or indirectly to the control system to be tested.

In the context of the development of such environment models, the current practice is to create such models in a modelling environment. One example is the widely used MatLab/Simulink (TheMathworks Inc.: “Simulink 6.5 (R2006b)”; September 2006). In such a modelling environment the functionality of the environment model is noted by means of so-called “blocks”. The connecting elements represent a control and/or data flow. In order to use, as intended, a prepared model in a test design, the model has to be executed on a suitable system in a translated form. Since the compile time can take several hours on account of the fact that such environment models comprise several thousand blocks, in particular, the lack of flexibility of larger environment models must be regarded—irrespective of the methods of parameterization—as a drawback.

In order to translate the program code for execution on such computer systems, which are often used without any user-suitable interfaces, such as a monitor or a keyboard, in an electrical/mechanical-electronic system, it is usually necessary to describe in exact detail the properties of the boundary conditions and the general conditions of the target computer system, because the generated programs are often executed directly in the target computer system and do not run, as known from the execution of programs on conventional personal computers, in a protected environment in the operating system. Generally the systems that are suitable for executing environment models

correspond to such computer systems. In this case they are often systems that are especially appropriate for simulation and exhibit specific hardware elements, such as connectors for sensors and actuators.

Due to the fixed general conditions of the target computer system, the computer architecture of such target systems and the processor-near compilation of the program code to be executed—in this case an environment model—the execution in such a target computer system is deemed in general to be deterministic. Therefore, on the one hand, the repeatability of an execution is guaranteed; on the other hand, before execution it can be determined in consideration of which components of the system the execution takes place.

The described test design generally uses an experiment PC and suitable software, for example ControlDesk (dSPACE GmbH: “ControlDesk 3.0”; release 5.2 of Dec. 14, 2006) to monitor the reactions of the control device to be tested. Furthermore, it is conceivable to use other suitable software—for example, AutomationDesk (dSPACE GmbH: “AutomationDesk 1.4” release 5.2 of Dec. 14, 2006)—to influence specifically the environment model in order to be able to determine exhaustively and comprehensively the reactions of the control device to be tested. In order to have a targeted impact on the environment model, it is necessary to have sufficient knowledge about the structure of the environment model, in particular the memory locations of the individual variables of the environment model.

The determinism of the execution makes it possible, already before executing the environment model on a specific target computer system—a test device—to obtain information about these memory locations. To this end, a description of the model, comprising the model blocks, outputs and possibly inputs with associated physical memory locations, as well as possibly additional information, is generated at the time that the compiling is done. In the expanded context of the present invention, the individual entries of the description are referred to below in certain places as the objects of a first type.

Ideally the description corresponds to the names used in the modelling environment for individual components (blocks) and reflects the model structure (in particular, for example the subsystems), so that identical or at least approximately comparable names ensure better recognition when such a description is used, for example, in the above-described programs (ControlDesk, AutomationDesk, . . . ).

One example of a possible form of the description is a simple block model, comprising two inputs, an addition block and an output block. The control flow provides that the values, available to the input blocks, are multiplied in the multiplication block and are then outputted to the output block. The syntax of the following description is purely exemplary.

In this case the individual elements of such a description are delimited from each other by means of curly braces. For the sake of a better understanding, the attributes of individual objects are added.

{simple.mod

| { in_01: int//0x00004314 } | |
|---|---|
| { in_02: int(const[1])//0x00004324 } | |
| { op_block_01: int//0x00004346 | |
| : method=multiply | } |

{ out_01: int//0x00004628 }

}

The cited description contains four objects, each of which represents a block in the model. If this model is executed on a test device and if one knows the block identifier—for example, “simple.mod.in.01”—referenced in the description, then this identifier can be used. The associated physical memory area is resolved by means of a computer and then—depending on the problem—read out or modified. A customary method is derived, for example, from the complex problem of calibration. In this case an artificial sliding controller, which exists in an experiment device—for example a computer mouse-controllable sliding controller with a fixed range of values—is linked with the object “simple.mod.in.02”, which is known from the description and which is a constant of the type “integer” with the initial value 1. The resolution of the actual physical memory addresses is taken over by the experiment system.

This method is adequately well-known and has been documented in the prior art for a long time. The application of this information shall be discussed in detail below by way of an example.

In a test such a description would serve—assuming that the physical memory locations of the variables of the environment model are known—to influence or read these memory locations of the variables of the environment model specifically by overwriting by means of a monitoring or experiment software—for example, ControlDesk or AutomationDesk—in order to determine the desired reactions of the unit to be tested—for example, a control unit. The development of test models or the solution of other problems in connection with the whole experiment are significantly facilitated through the consistent use of identical identifiers.

In the field it has proved worthwhile to provide this description, comprising the identifiers, separately from the model.

In the European patent application—application no. EP 06/018.945.3—Leinfellner et al. describe a method that carries out the aforementioned influencing not from an experiment PC, but directly on the test device. Particular characterizing features of the method are that, in addition to the environment model, at least one test model is executed on the test device, that there is a certain functional independence; and that—in test mode—the test model is executed synchronously with the environment model within the scope of the method, described in said application.

The described synchronous execution of two models on a test device requires that the exemplary experiment design, on which a specified computing and sampling frequency is based, has a model, which controls the synchronization, and/or a higher-ranking mechanism that controls the execution of both models. Such a mechanism can comprise, for example, a timer, which brings about the execution of that portion of the environment model and the test model that is relevant for this unit of time at the start of a unit of time, based on the computing and sampling frequency. Furthermore, such a mechanism can comprise means, which check that the real time criteria are met and which make, for example, error entries when the allowable units of time are exceeded or which execute other actions to be specified. In particular, problems with very strict requirements with respect to real time conditions and synchronicity can be solved with much higher accuracy with this procedure than in the conventional methods of operating a test device from an experiment PC.

The development of test models—for example, by means of conventional programming languages or graphics notations (for example, by means of the cited Simulink software)—is significantly simplified through the use of the aforementioned description of the model. The conventional development process uses the identifiers, which are listed in the description and are a part of the individual environment model components (blocks), to create test models, which are easier to read as compared to the specific use of physical memory addresses. Not until the test model, which is created thus, is executed (or compiled) are the identifiers that are used converted into the corresponding physical memory addresses.

In particular, the consistent use of identical identifiers for a variety of different tasks in a test procedure gives a good overview. However, one drawback is that a description, which is generated while compiling an environment model, has a static character similar to the environment model. Therefore, a dynamic use of the identifiers in the whole test design is desirable.

Therefore, the object and goal of the present invention is to provide a method and a device for the dynamic treatment of objects so that the aforementioned drawbacks are avoided—at least to some degree.

The invention achieves, according to a first teaching of the invention, the above-described object with a method for the dynamic treatment of objects in a test design. According to this method, the test design comprises at least two bidirectionally exchanging systems and at least one additional system to be tested. The objects of a first type belong to an environment model, which is executed on a first system, and these objects can be processed by a test model. Objects of a second type that are similar or identical to the objects of the first type are generated; and the objects of a first and a second type are made available to at least one of the systems by means of a management device.

The distinction between the inventive method and the known and described methods of the prior art lies in the many advantages of the inventive method from a variety of viewpoints. The drawback of a lack of dynamics in static descriptions, and/or static objects of a first type, is remedied by the possibility of generating dynamically objects of a second type, which are, according to a first teaching, identical or similar in type.

The objects of a second type correspond, according to a first teaching of the invention, at least structurally to the objects of a first type. In a typical application, on which the inventive idea is based, the physical memory addresses are determined—as described—by means of a computer-aided resolution of the objects. According to the method, described by Leinfellner et al., this computer-aided resolution of objects of a first type can also be performed on the test device itself. At this stage objects of a second type are to be generated in accordance with the invention.

This is explained with a fictitious example. The problem of this example is to make a modification in the simple model, described in the introductory part, so that the output value of the multiplication is changed by a controllable factor.

One solution, according to the method, claimed by Leinfellner et al., consists, for example, of designing a test model, which—polled cyclically while observing the model-related real time criteria—reads the output value of the multiplication block “simple.mod.op.block.01”, multiplies by the factor and outputs the result on the output block “simple.mod.out.01”. However, it is desirable, according to the aforementioned problem, that the factor should be controllable.

To this end, the use of experiment software, as known from the prior art, is suitable. This software can determine the associated physical memory addresses with the inclusion of objects of the first type and can document with (new) values. It is not possible in this way to access the factor, implemented in the test model.

At this stage the problem in the test model is solved, for example, by generating an object of a second type, which is addressed by the identifier “simple.mod.gain_block_{—}01” and contains a parameter “factor”, which has, for example, an initial value of 1. In an exemplary embodiment the management device makes this object available to the experiment PC. In the PC the associated physical addresses of the factor (in this case, for example, the address of the gain block, thus a multiplier) can be determined, as described above, if the object identifier is known. This factor can be modified, for example, by means of sliding controllers. The instructions in the test model to multiply the output value of the multiplication block “simple.mod.op_block_{—}01” by a factor and to output the result, remain, supplemented by the said procedure, unaffected.

Another embodiment of the inventive method is characterized in that the objects of the second type are generated, in particular, by means of the test model or parts of the test model, and/or the generation is initiated by them. According to the described test design, a test model is executed on the test device. However, it is also conceivable—in differentiating from this embodiment—that the generation of new objects is done or initiated by other experiment systems or additional systems.

An especially preferred embodiment of the inventive method provides that the existence of objects of the second type is coupled with the execution and/or the start of the test model and/or by parts of the test model. Consequently in other especially preferred embodiments the objects of the second type are deleted upon or after termination of the test model. Furthermore, it is provided that the test model can make changes in the objects of the second type.

According to the method, on which the invention is based, the objects of the second type are usually linked to an additional treatment by means of a specification of any design—ideally a problem, which is represented by means of a test model and is derived from a control engineering context. Therefore, insofar as this specification no longer exists in an overall experiment, the object of the second type is deleted, according to the invention.

In another preferred embodiment objects of the second type can be linked with other objects—of a first and/or second type. It is advantageous within the scope of the invention to bridge the functionality of an environment model by means of the functionality of a test model. For example,—referring to the aforementioned example—the multiplication block “simple.mod.op_block_{—}01” can be replaced by another calculation specification. To this end, an object of a second type is generated that is coupled, according to the problem, to the modified calculation specification. Then this object is linked to the desired output block—here, for example, an object of a first type: “simple.mod.out_{—}01”—in the calculation specification or in some other way so that the value is transferred cyclically—ideally in consideration of the scheduling process, described by Leinfellner et al. Any other bidirectional combination of objects of a first and second type is conceivable within the limits of possible calculation specifications.

Moreover, variants, which provide the generated objects of a second type for further processing and/or control, for preparing experiments or for after-treatment of larger amounts of results are conceivable.

According to another preferred embodiment of the inventive method, the information about the objects of a first and second type as well as the modifications of the objects of a second type are managed by means of a management device and are made available to other systems in the test design.

The management device, localized on the test device according to a preferred embodiment, puts the objects of the first and second type at disposal for further application. In an especially preferred embodiment this management device is controlled directly or indirectly by means of the test model and/or a mechanism, which executes the test model. This mechanism or the test model files information about objects of the second type in the management device. According to the embodiment, the management device actively reports this information and/or the presence of information to other systems, for example, by means of trigger signals. According to another embodiment, it is conceivable that the management device is queried cyclically by means of other systems; therefore, it does not report until requested. As an alternative, the management device holds the message and/or the information ready for use in a memory.

In other preferred embodiments, the inventive method and the device are designed in such a manner that the process steps that are described within the scope of this invention can be carried out with said inventive method and device.

In detail, there are now a plurality of possibilities of designing and further developing the inventive method and the management device. In this respect reference is made to both the patent claims following patent claims 1 and 10 and to the description of the embodiments of the inventive method depicted in the drawings.

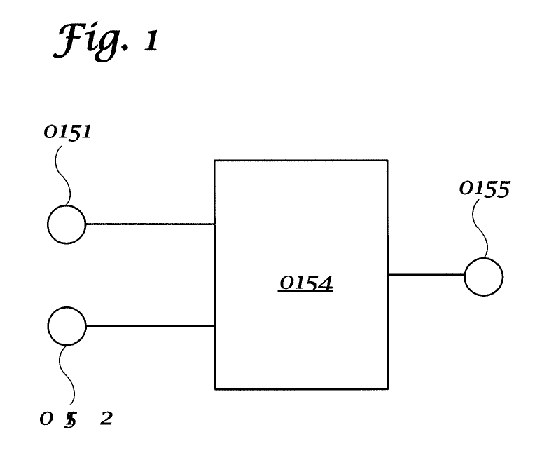

FIG. 1 is a schematic representation of a simple model.

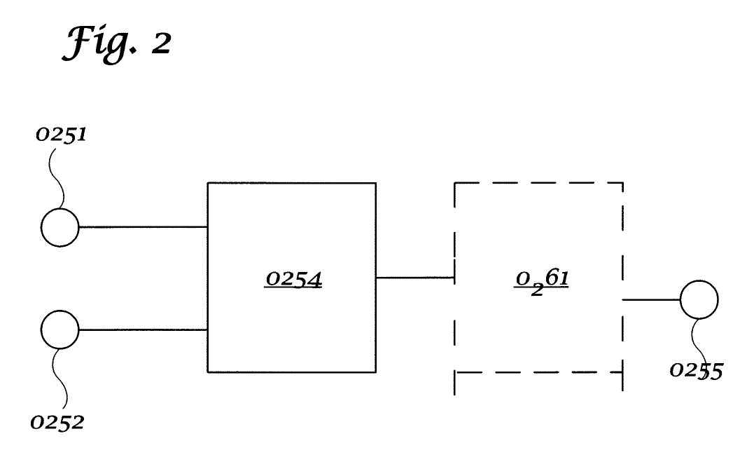

FIG. 2 is a schematic representation of a simple model, expanded by one component, which corresponds to an object of a second type, in particular based on the claims 1 to 9.

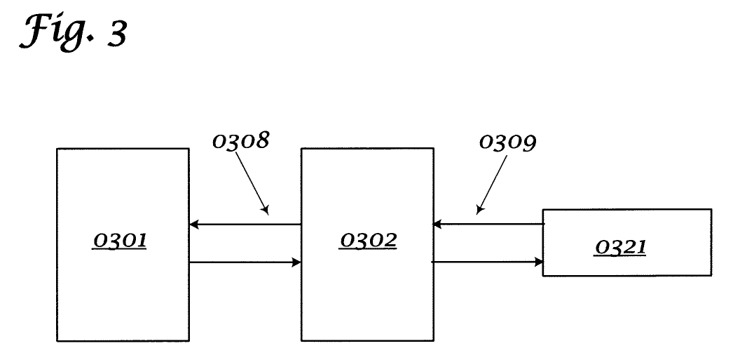

FIG. 3 is a schematic representation of a test design, on which the inventive idea is based and which comprises two bidirectionally operating systems and an additional system to be tested; and

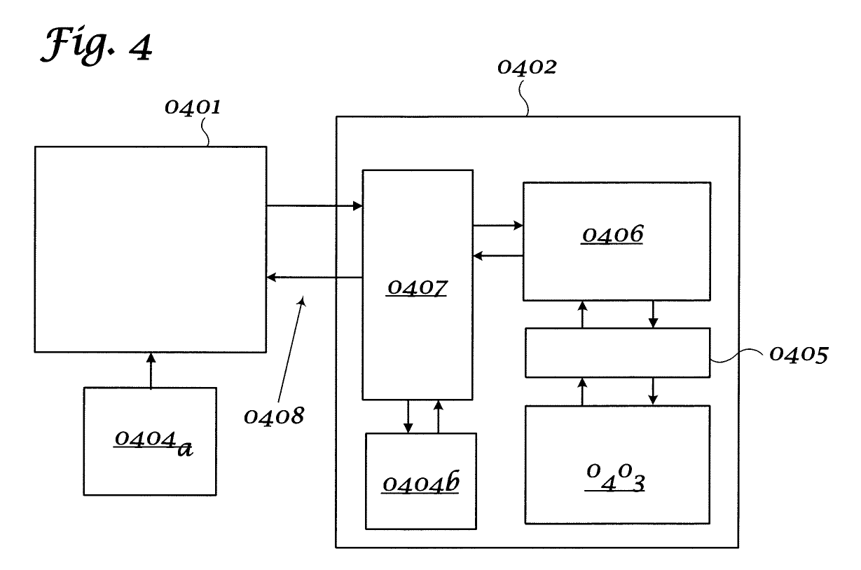

FIG. 4 is a schematic representation of a test device within the scope of the present invention, taking into consideration a management device, according to the claims, in particular based on the method, according to claim 1.

FIGS. 1 to 4 depict certain aspects of the inventive method and the inventive device by means of various embodiments. For the sake of a better overview, the figures and the descriptions with respect to the figures show a simplified version of the preferred embodiments to facilitate a better understanding.

FIG. 1 is a schematic drawing of a simple model in graphic notation. The first and foremost element 0151, 0152—for example, a data source—in the control and data flow sends the received values to the next element 0154—for example, a multiplication block, as in the above-described example. This block executes the integrated operation—in this case, therefore, a multiplication of the values received from the elements 0151, 0152 and outputs the received result to an outputting element 0155—for example, a data sink.

FIG. 2 is a schematic drawing, depicting how a really non-existing block 0261, which corresponds to a so-called object of a second type, is integrated—for example, in the form of a multiplier, as in the above-described example—in the existing environment model (consisting of 0251, 0252, 0254, 0255) from the user's view. In the present embodiment, for example, the really non-existing block 0261 contains a calculation specification, which influences the result of the multiplication of the block 0254 and outputs this influenced, new result to the block 0255. In another distinct embodiment (not illustrated) of the invention, the fictitious block 0261 would contain an additional object of a second type, representing a block, which contains the factor of the multiplier in the form of a constant. If the identifier that was used were known, this additional object could be influenced starting from the experiment software. However, it is also conceivable that other components of a test model could also have an impact.

FIG. 3 depicts a test design within the scope of the present invention. A unit 0321 to be tested is connected bidirectionally to a test device 0302 by means of the data transfer means 0309. This test device in turn interacts over data transfer means 0308 with an additional system 0301, preferably an experiment PC. The present invention exhibits a particular value added when a test device 0302 interacts with an experiment PC 0301 in a test design. In particular, it is especially advantageous to use the physical memory locations of the objects of a second type that can be addressed by means of identifiers, using experiment software and/or test software and/or other test models in accordance with the invention, disclosed by Leinfellner et al.

FIG. 4 is a schematic drawing of various details of a test design as well as other components, on which the test design is essentially based. In particular, the drawing shows a system—in this case, an experiment system 0401, which has the description 0404a in the form of a separate file in the example. Moreover, the drawing shows a test device 0402 with a physical memory 0405, an executed environment model 0403, an executed test model 0406 as well as a management device 0407 for the treatment of objects of a first and second type. Furthermore, the drawing shows a corresponding description 0404b, which reproduces the content of the description 0404a and which is available to the management device. Furthermore, the drawing lists (not exhaustively) various data flows between the cited objects in the test device 0402.

### LIST OF REFERENCE NUMERALS

Letter indices usually refer to a plurality of events of one type or variants of identical or similar
0151 Schematic representation of an input block
0152 Schematic representation of an input block
0154 Schematic representation of an operation block
0155 Schematic representation of an output block
0251 Schematic representation of an input block
0252 Schematic representation of an input block
0254 Schematic representation of an operation block
0255 Schematic representation of an output block
0261 Schematic representation of a block in the sense of an object, according to a second type
0301 Experiment system
0302 Test device
0308 Data transfer means between the experiment system and the test device, according to claim 1
0309 Data transfer means between the test device and the system to be tested
0321 System to be tested
0401 Experiment system
0402 Test device
0403 Executed environmental model
0404 a: Description of the objects of the first type as a separate file
0404 b: Description of the objects of the first type as a retrievable data source of the test device
0405 Physical memory on the test device
0406 Executed test model
0407 Management device, according to the present invention
0408 Active and/or passive placing at disposal, according to claim 11

1. Method for the dynamic treatment of objects in a test design, wherein the test design comprises at least two bidirectionally exchanging systems and at least one additional system to be tested, wherein the objects of a first type belong to an environment model, which is executed on a first system, and these objects can be processed by a test model,
characterized in that
objects of a second type that are similar or identical to the objects of the first type are generated; and the objects of a first and a second type are made available to at least one of the systems by means of a management device.

2. Method, as claimed in claim 1, characterized in that the generation of the objects of the second type is initiated and/or executed by means of the test model and/or functional components of the test model.

3. Method, as claimed in any one of the preceding claims, characterized in that the generation of the objects of a second type is initiated and/or executed by means of the test model and/or functional components of the test model at the start of the test model or at the run time of the test model.

4. Method, as claimed in any one of the preceding claims, characterized in that the objects of the second type are deleted when the test model terminates.

5. Method, as claimed in any one of the preceding claims, characterized in that the objects of a second type are deleted or modified by means of the test model.

6. Method, as claimed in any one of the preceding claims, characterized in that the creation, modification or deletion of objects of a second type is made available to other systems by means of the management device.

7. Method, as claimed in any one of the preceding claims, characterized in that the objects of a second type can be linked to other objects of a second type and/or objects of a first type.

8. Method, as claimed in any one of the preceding claims, characterized in that an object of a second type is implemented in the form of calculation specifications and/or functions.

9. Method, as claimed in any one of the preceding claims, characterized in that the second system is a standard PC that is suitable for executing experiment software.

10. Method, as claimed in any one of the preceding claims, characterized in that a management device supplies in an active or passive manner the information about the objects of the first and second type.

11. Management device, as claimed in any one of the preceding claims, characterized in that the calling up and termination of the management device is linked to the start and termination of the test model.
